(19) United States
(12) Patent Application Publication
(10) Pub. No.: US 2012/0133884 A1
(43) Pub. Date: May 31, 2012

(54) ELECTRONIC GLASSES

(76) Inventor: Akihito ISHIDA, Osaka (JP)

(21) Appl. No.: 13/279,894

(22) Filed: Oct. 24, 2011

(30) Foreign Application Priority Data
Nov. 25, 2010 (JP) 2010-262846

(51) Int. Cl. G02C 5/00

(52) U.S. Cl. 351/158

(57) ABSTRACT

A pair of 3D glasses of the present invention includes an optical detecting section which is provided in a frame for detecting whether or not the pair of 3D glasses is being worn by a user. The optical detecting section has (i) an LED which emits detection light which is used to detect a user who is wearing the pair of 3D glasses and (ii) a PD which receives the detection light which has been emitted by the LED and is then reflected from the user.

This Nonprovisional application claims priority under 35 U.S.C. §119(a) on Patent Application No. 2010-262846 filed in Japan on Nov. 25, 2010, the entire contents of which are hereby incorporated by reference.

### TECHNICAL FIELD

The present invention relates to a pair of electronic glasses which electrically carries out function control. Specifically, the present invention relates to a pair of electronic glasses which (i) optically detects whether or not the pair of electronic glasses is being worn by a user and thereby (ii) automatically controls a power source of the pair of electronic glasses to be turned on or off.

### BACKGROUND ART

Conventionally, a technique has been known in which an image, which is displayed on a screen of a display device such as a TV (Television) or a PC (Personal Computer), is stereoscopically viewed by a user who is wearing a pair of 3D (three-dimensional) glasses having liquid crystal shutter lenses. According to such a stereoscopic viewing technique, a right-view image and a left-view image are alternately displayed on a screen of a display device, and a pair of 3D glasses repeatedly alternates (i) opening of a liquid crystal shutter for a right eye lens of the pair of 3D glasses while the right-view image is being displayed and (ii) opening of a liquid crystal shutter of a left eye lens of the pair of 3D glasses while the left-view image is being displayed. This allows a user to have a stereoscopic vision.

FIG. 12 is a perspective view illustrating a pair of conventional 3D glasses 100. The pair of 3D glasses 100 has a frame 111 in which a right eye lens 112, a left eye lens 113, a control circuit containing section 114, a synchronization signal receiving section 115, and a battery containing section 116 are provided (see FIG. 12).

According to the pair of 3D glasses 100, a synchronization signal, which is indicative of timing of switching of frames, is transmitted from a TV or a PC and is then received by the synchronization signal receiving section 115 which is provided in a bridge part of the frame 111. The synchronization signal thus received is supplied to a control circuit contained in the control circuit containing section 114. The control circuit analyzes the synchronization signal so as to control, based on the analysis, the right eye lens 112 and the left eye lens 113 to open or close. This makes it possible to carry out basic operation, i.e., synchronization between an image displayed by a display device and the opening or closing of the right and left eye lenses 112 and 113.

In general, a pair of conventional 3D glasses such as the one illustrated in FIG. 12 has a power switch. When the power switch is turned on, the pair of 3D glasses operates in the manner above described. When the power switch is turned off, the pair of 3D glasses stops operating.

Moreover, a pair of 3D glasses, which has a function to automatically control a power source to be turned off, has been put into practical use. According to such a pair of 3D glasses, in a case where the pair of 3D glasses being turned on does not receive, from the display device, a signal such as the synchronization signal, a right-view information signal, or a left-view information signal for a predetermined period of time, the pair of 3D glasses automatically controls the power source to be turned off for reducing unnecessary power consumption.

However, it sometimes happens that a user, who is wearing a pair of 3D glasses, incorrectly recognizes that the pair of 3D glasses is in operation, even though a power source of the pair of 3D glasses has been automatically turned off without operating the power switch. This causes a problem of discrepancy between the actual operation state of the pair of 3D glasses and the recognition of the user.

In relation to the problem, a technique has been proposed in which power supply is automatically turned on or off, without using a power switch, by detecting whether or not a pair of 3D glasses is being worn by a user. For example, Patent Literature 1 discloses a pair of bifocal electronic glasses which (i) has a switch incorporated in nose pads of a frame and (ii) automatically controls the power supply to be turned on when the nose pads are pressed by a nose of user who is wearing the pair of electronic glasses.

### CITATION LIST

### Patent Literature

### Patent Literature 1

Japanese Patent Application Publication, Tokukai, No. 2007-212501 (Publication Date: Aug. 23, 2007)

### Patent Literature 2

Japanese Patent Application Publication, Tokukai, No. 2002-297088 (Publication Date: Oct. 9, 2002)

### SUMMARY OF INVENTION

### Technical Problem

It sometimes happens that a user, who usually wears a pair of corrective glasses for nearsightedness or astigmatism, further wears a pair of 3D glasses.

According to the technique disclosed in Patent Literature 1, however, the nose pads need to contact with the nose of the user, and therefore the following problem occurs when the technique disclosed in Patent Literature 1 is applied to a pair of 3D glasses. That is, with the technique disclosed in Patent Literature 1, when a user who is wearing a pair of corrective glasses further puts on the pair of 3D glasses, the nose pads do not contact with the nose of the user, and therefore whether or not the user is wearing the pair of 3D glasses cannot be detected properly.

The present invention is accomplished in view of the conventional problem, and its object is to provide a pair of electronic glasses which can properly detect whether or not the pair of electronic glasses is being worn by a user, regardless of whether or not the user is wearing a pair of corrective glasses.

### Solution to Problem

A pair of electronic glasses of the present invention electrically carries out function control and includes: optical detecting means, provided in a frame of the pair of electronic glasses, for detecting whether or not the pair of electronic glasses is being worn by a user, the optical detecting means including: light-emitting means for emitting detection light based on which the optical detecting means detects whether the user is wearing the pair of electronic glasses, and light-receiving means for receiving the detection light which has been emitted by the light-emitting means and is then reflected from the user.

According to the configuration, the light-emitting means and the light-receiving means are located so that the detection light, which has emitted by the light-emitting means and is then reflected from the user, is received by the light-receiving means.

With the configuration, in a case where the user is wearing the pair of electronic glasses, the detection light which has been emitted by the light-emitting means is reflected by the user, and accordingly the light-receiving means receives the detection light. On the other hand, in a case where the pair of electronic glasses is not worn by the user, the detection light emitted by the light-emitting means would not be reflected by the user, and therefore the light-receiving means will never receive the detection light.

According to the present invention having such configuration, the optical detecting means, which is not in contact with a user, can detect, in accordance with a detected result of detection light by the light-receiving means, whether or not the pair of electronic glasses is being worn by a user.

According to the present invention, it is possible to provide a pair of electronic glasses which can properly detect whether or not the pair of electronic glasses is being worn by a user, regardless of whether or not the user is wearing a pair of corrective glasses.

### Advantageous Effects of Invention

As described above, the pair of electronic glasses of the present invention electrically carries out function control and includes: optical detecting means, provided in a frame of the pair of electronic glasses, for detecting whether or not the pair of electronic glasses is being worn by a user, the optical detecting means including: light-emitting means for emitting detection light based on which the optical detecting means detects whether the user is wearing the pair of electronic glasses, and light-receiving means for receiving the detection light which has been emitted by the light-emitting means and is then reflected from the user.

The configuration makes it possible to provide the pair of electronic glasses which can properly detect whether or not the pair of electronic glasses is being worn by a user, regardless of whether or not the user is wearing a pair of corrective glasses.

### BRIEF DESCRIPTION OF DRAWINGS

FIG. 1 is a perspective view illustrating an external appearance of a pair of 3D glasses in accordance with an embodiment of the present invention.

FIG. 2 is a block diagram illustrating a main configuration of the pair of 3D glasses illustrated in FIG. 1.

FIG. 3 is a top view illustrating a state where the pair of 3D glasses illustrated in FIG. 1 is being worn by a user.

FIG. 4 is a top view illustrating a state where the pair of 3D glasses illustrated in FIG. 1 is not worn by a user.

FIG. 5(a) is a timing chart of detection light which is emitted by an LED while the pair of 3D glasses illustrated in FIG. 1 is being worn by a user.

FIG. 5(b) is a timing chart of detection light which is received by a PD while the pair of 3D glasses illustrated in FIG. 1 is being worn by a user.

FIG. 6(a) is a timing chart of detection light which is emitted by an LED while the pair of 3D glasses illustrated in FIG. 1 is not worn by a user.

FIG. 6(b) is a timing chart of detection light which is received by a PD while the pair of 3D glasses illustrated in FIG. 1 is not worn by a user.

FIG. 7(a) is a timing chart of detection light which is intermittently emitted by an LED while the pair of 3D glasses illustrated in FIG. 1 is being worn by a user.

FIG. 7(b) is a timing chart of detection light which is intermittently emitted and is then received by a PD while the pair of 3D glasses illustrated in FIG. 1 is being worn by a user.

FIG. 8(a) is a timing chart of detection light which is intermittently emitted by an LED while the pair of 3D glasses illustrated in FIG. 1 is not worn by a user.

FIG. 8(b) is a timing chart of detection light which is intermittently emitted and is then received by a PD while the pair of 3D glasses illustrated in FIG. 1 is not worn by a user.

FIG. 9(a) is a timing chart illustrating an amount of detection light emitted by an LED, for explaining how a power source of the pair of 3D glasses illustrated in FIG. 1 is controlled to be turned on or off.

FIG. 9(b) is a timing chart illustrating an amount of detection light received by a PD, for explaining how a power source of the pair of 3D glasses illustrated in FIG. 1 is controlled to be turned on or off.

FIG. 9(c) is a timing chart illustrating how a control section controls a power source to be turned on or off, for explaining how the power source of the pair of 3D glasses illustrated in FIG. 1 is controlled to be turned on or off.

FIG. 10 is a schematic view illustrating a first modified example of the pair of 3D glasses illustrated in FIG. 1.

FIG. 11 is a schematic view illustrating a second modified example of the pair of 3D glasses illustrated in FIG. 1.

FIG. 12 is an external view illustrating a configuration of a pair of conventional 3D glasses.

### DESCRIPTION OF EMBODIMENTS

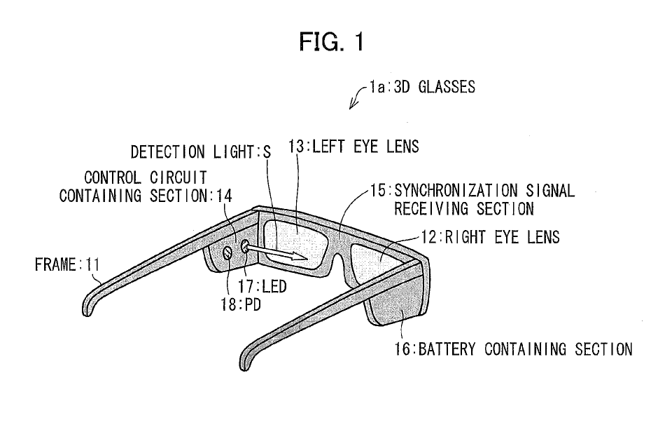

The following describes an embodiment of a pair of electronic glasses in accordance with the present invention, with reference to FIGS. 1 through 11. The present embodiment will discuss a case where the pair of electronic glasses of the present invention is applied to a pair of 3D glasses.

### [1] Configuration of 3D Glasses

First, the following describes a configuration of a pair of 3D glasses in accordance with the present embodiment, with reference to FIGS. 1 through 4. The pair of 3D glasses of the present embodiment receives, from a display device such as a TV (Television) or a PC (Personal Computer), synchronization signals of a right-view image and a left-view image. The pair of 3D glasses repeatedly alternates, in response to the synchronization signals, (i) opening of a liquid crystal shutter for a right eye lens of the pair of 3D glasses while the display device is displaying the right-view image and (ii) opening of a liquid crystal shutter for a left eye lens of the pair of 3D glasses while the display device is displaying the left-view image. This allows a user to have a stereoscopic vision.

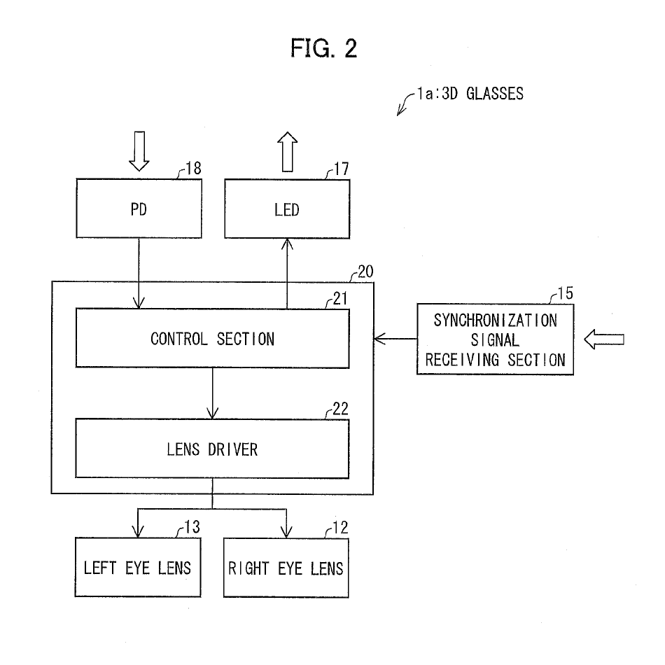

FIG. 1 is a perspective view illustrating an external appearance of a pair of 3D glasses 1a in accordance with the present embodiment. FIG. 2 is a block diagram illustrating a main configuration of the pair of 3D glasses 1a illustrated in FIG. 1. The pair of 3D glasses 1a includes a right eye lens 12, a left eye lens 13, a synchronization signal receiving section 15, an LED (Light Emitting Diode: light-emitting means) 17, a PD (Photo Diode: light-receiving means) 18, and a control circuit 20 (see FIG. 2).

Each of the right eye lens 12 and the left eye lens 13 is a liquid crystal shutter lens whose opening or closing can be controlled in response to an applied voltage. In each of the right eye lens 12 and the left eye lens 13, the liquid crystal shutter is controlled to open or close in response to a corresponding one of the synchronization signals received by the synchronization signal receiving section 15.

The synchronization signal receiving section 15 receives, from a display device such as a TV or a PC, a signal such as a synchronization signal indicative of switching timing of frames. The synchronization signal receiving section 15 is provided so as to receive the synchronization signals from the display device. In the present embodiment, the synchronization signal receiving section 15 is provided at a bridge part of a frame 11 of the pair of 3D glasses 1a.

The LED 17 and the PD 18 constitute an optical detecting section which detects whether or not the pair of 3D glasses 1a is being worn by a user.

The LED 17 is a light-emitting element which emits, at predetermined timing, detection light S which is used to detect a user. Specifically, the LED 17 emits the detection light S which is used to detect, in response to a control signal supplied from the control circuit 20, whether or not the pair of 3D glasses 1a is being worn by a user. Note that, according to the present embodiment, the LED 17 is used as a light-emitting element. However, the present embodiment is not limited to this. It is therefore possible to use another light-emitting element instead of the LED 17.

The PD 18 is a light-receiving element which receives detection light S which has been emitted by the LED 17 and reflected from a user. When the PD 18 receives the detection light S, the PD 18 supplies, to the control circuit 20, a detection signal indicative of an amount of the received detection light S. Note that, according to the present embodiment, the PD 18 is used as a light-receiving element. However, the present embodiment is not limited to this. It is therefore possible to use another light-receiving element instead of the PD 18.

The control circuit 20 controls entire operations of the pair of 3D glasses 1a. According to the present embodiment, the control circuit 20 is contained in a control circuit containing section 14 which is provided in a temple part of the frame 11. The control circuit 20 includes a control section 21 (control means, charging control means) and a lens driver 22.

The control section 21 controls each section of the pair of 3D glasses 1a. Specifically, the control section 21 controls the LED 17 to emit detection light S. Moreover, when the control section 21 receives, from the PD 18, a detection signal indicative of a light amount of not less than a predetermined light amount, the control section 21 determines that the pair of 3D glasses 1a is being worn by a user, and then turns on a power source (a device power source) of the pair of 3D glasses 1a. While a detection signal is being supplied to the control section 21, the control section 21 controls the lens driver 22 to carry out a predetermined process.

On the other hand, when the supply of the detection signal from the PD 18 is stopped, the control section 21 determines that the user has ceased to use the pair of 3D glasses 1a, controls the lens driver 22 to stop the operation, and turns off the power source of the pair of 3D glasses 1a. Then, the control section 21 controls the power source to keep being turned off until receiving another detection signal indicative of a light amount of not less than the predetermined light amount from the PD 18. This is how the control section 21 controls, based on a detection signal supplied from the PD 18, the power source of the pair of 3D glasses 1a to turn on or off.

The control section 21 further controls a rechargeable battery (not illustrated) contained in a battery containing section 16 to be charged. The control section 21 controls the rechargeable battery not to be charged, in a case where, for example, the power source of the pair of 3D glasses 1a is turned on and is therefore in an operating state. This makes it possible to prevent a trouble, such as gas generation from the rechargeable battery and/or liquid leakage from inside of the rechargeable battery, which is caused when the rechargeable battery is overcharged due to a defect of the control circuit 20 or the rechargeable battery.

Note that the control section 21 controls the LED 17 to periodically emit detection light S, regardless of whether the power source of the pair of 3D glasses 1a turns on or off, so as to appropriately detect whether or not the pair of 3D glasses 1a is being worn by a user.

The lens driver 22 controls the liquid crystal shutters of the right eye lens 12 and the left eye lens 13 to open or close by applying voltages to the respective liquid crystal shutters. Specifically, the lens driver 22 controls the liquid crystal shutters of the right eye lens 12 and the left eye lens 13 to open or close based on the synchronization signals received by the synchronization signal receiving section 15. This makes it possible to synchronize a right-view image and a left-view image displayed on the screen of the display device with opening or closing of the liquid crystal shutters of the right eye lens 12 and the left eye lens 13.

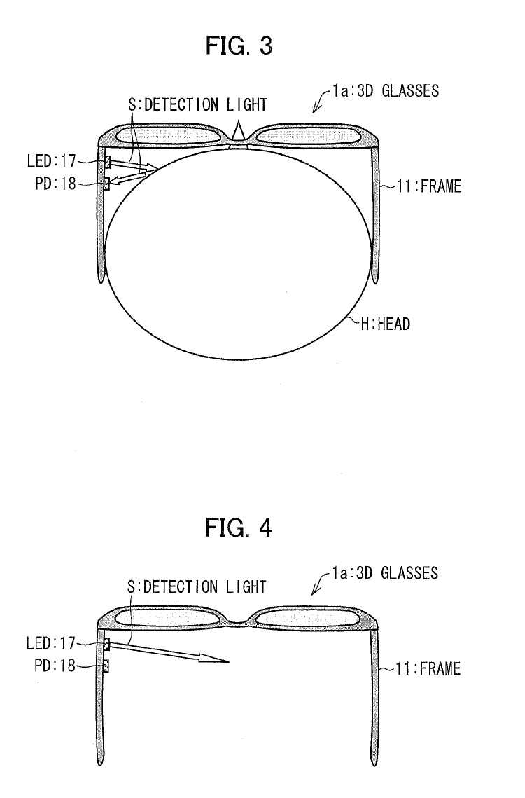

FIG. 3 is a top view illustrating a state where the pair of 3D glasses 1a illustrated in FIG. 1 is being worn by a user. In the state where the pair of 3D glasses 1a is being worn by the user, detection light S, which has been emitted by the LED 17, is reflected from a head H of the user and is then received by the PD 18 (see FIG. 3). The control section 21 therefore receives the detection light S from the PD 18. While receiving the detection signal from the PD 18, the control section 21 (i) determines that the pair of 3D glasses 1a is being worn by the user and (ii) controls the lens driver 22 to drive the right eye lens 12 and the left eye lens 13. In other words, the control section 21 controls the power source of the pair of 3D glasses 1a to keep being turned on while receiving the detection signal from the PD 18.

Note that the LED 17 and the PD 18 are provided so that the PD 18 receives the detection light S reflected from the head H of the user. According to the present embodiment, the LED 17 and the PD 18 are provided in a control circuit containing section 14 which is provided in the temple part of the frame 11.

FIG. 4 is a top view illustrating a state where the pair of 3D glasses 1a illustrated in FIG. 1 is not being worn by a user. In the case where the pair of 3D glasses 1a is not being worn by a user, detection light S which has been emitted from the LED 17 keeps traveling straight without being reflected (see FIG. 4). This causes the detection light S not to be received by the PD 18, and therefore the control section 21 will never receive any detection signal from the PD 18. This causes the control section 21 to determine that the pair of 3D glasses 1a is not being worn by the user, and the control section 21 controls the lens driver 22 not to operate until receiving a detection signal from the PD 18. In other words, the control section 21 controls the power source of the pair of 3D glasses 1a to keep being turned off while receiving no detection signal from the PD 18.

The pair of 3D glasses 1a of the present embodiment is configured to detect, with the use of the LED 17 and the PD 18 which constitute an optical detecting section, whether or not the pair of 3D glasses 1a is being worn by a user. The optical detecting section can detect a user without directly contacting with the user. It is therefore possible to appropriately detect a user even in a case where the user, who usually wears a pair of corrective glasses for nearsightedness or astigmatism, further wears the pair of 3D glasses.

### [2] User Detection Process of 3D Glasses

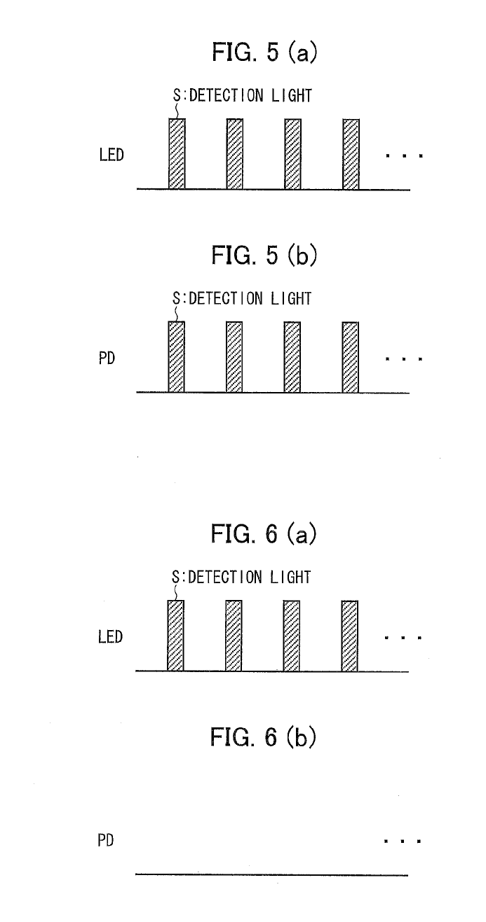

The following describes how the pair of 3D glasses 1a detects a user, with reference to FIGS. 5(a) through 9(c).

Each of FIGS. 5(a) and 5(b) is a timing chart illustrating how detection light S changes while the pair of 3D glasses 1a is being worn by a user. FIG. 5(a) illustrates detection light S emitted by the LED 17, and FIG. 5(b) illustrates detection light S received by the PD 18.

In a state where the pair of 3D glasses 1a is being worn by a user, the detection light S, which has been emitted by the LED 17 (see FIG. 5(a)), is reflected by the user and then travels toward the PD 18. This causes the detection light S to be received by the PD 18 (see FIG. 5(b)). In this case, a detection signal is supplied from the PD 18 to the control section 21. The control section 21 therefore controls the power source of the pair of 3D glasses 1a to be turned on so that the lens driver 22 keeps operating, while receiving the detection signal from the PD 18.

Each of FIGS. 6(a) and 6(b) is a timing chart illustrating how detection light S changes while the pair of 3D glasses 1a is not being worn by a user. FIG. 6(a) illustrates detection light S emitted by the LED 17, and FIG. 6(b) illustrates the detection light S received by the PD 18.

In a state where the pair of 3D glasses 1a is not being worn by a user, the detection light S, which has been emitted by the LED 17 (see FIG. 6(a)), keeps traveling straight without being reflected by the user. Therefore, the detection light S is not received by the PD 18 (see FIG. 6(b)). In this case, the control section 21 receives no detection signal from the PD 18, and therefore controls (i) the lens driver 22 to stop operating and (ii) the power source of the pair of 3D glasses 1a to turn off.

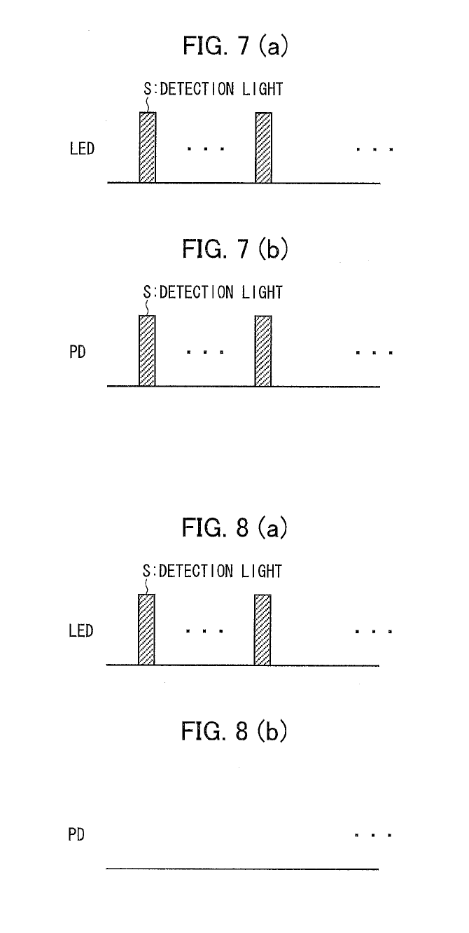

Each of FIGS. 7(a) and 7(b) is a timing chart illustrating detection light S which is intermittently emitted by the LED 17 while the pair of 3D glasses 1a is being worn by a user. FIG. 7(a) illustrates detection light S emitted by the LED 17, and FIG. 7(b) illustrates detection light S received by the PD 18.

In a state where the pair of 3D glasses 1a is being worn by a user, the detection light S, which has been emitted by the LED 17 (see FIG. 7(a)), is reflected from the user toward the PD 18. Accordingly, the detection light S, which has been intermittently emitted, is received by the PD 18 (see FIG. 7(b)). In this case, the control section 21 receives a detection signal from the PD 18, and therefore controls (i) the power source of the pair of 3D glasses 1a to be turned on and (ii) the lens driver 22 to keep operating, while receiving the detection signal from the PD 18.

Each of FIGS. 8(a) and 8(b) is a timing chart illustrating detection light S which is intermittently emitted while the pair of 3D glasses 1a is not being worn by a user. FIG. 8(a) illustrates detection light S emitted by the LED 17, and FIG. 8(b) illustrates detection light S received by the PD 18.

In a state where the pair of 3D glasses 1a is not worn by a user, the detection light S, which has been intermittently emitted by the LED 17 (see FIG. 8(a)), keeps traveling straight without being reflected by the user. Therefore, the detection light S is not received by the PD 18 (see FIG. 8(b)). In this case, the control section 21 receives no detection signal from the PD 18, and therefore controls (i) the lens driver 22 to stop operating and (ii) the power source of the pair of 3D glasses 1a to turn off.

In case of the configuration in which the detection light S is thus intermittently emitted, it is possible to reduce power consumption, and it is therefore possible to extend operating time of the pair of 3D glasses 1a.

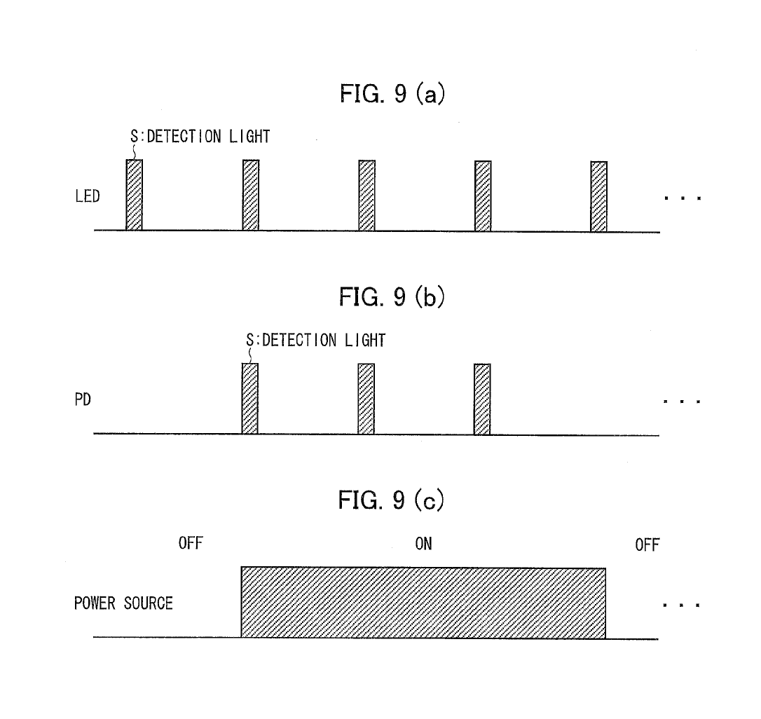

Each of FIGS. 9(a) through 9(c) is a timing chart illustrating how the power source of the pair of 3D glasses illustrated in FIG. 1 is controlled to be turned on or off. FIG. 9(a) illustrates an amount of detection light S emitted by the LED 17. FIG. 9(b) illustrates an amount of detection light S received by the PD 18. FIG. 9(c) illustrates how the control section 21 controls the power source to be turned on or off.

In a case where the control section 21 receives a detection signal supplied from the PD 18 when the power source of the pair of 3D glasses 1a turns off, the control section 21 controls the power source of the pair of 3D glasses 1a to change from being turned off to being turned on so as to control the lens driver 22 to operate.

That is, the control section 21 controls the power source of the pair of 3D glasses 1a to change from being turned off to being turned on when the user puts on the pair of 3D glasses 1a. Then, the control section 21 controls the power source of the pair of 3D glasses 1a to keep being turned on while receiving the detection signal from the PD 18 (see FIGS. 9(a) through 9(c)).

Moreover, when the control section 21 receives no detection signal from the PD 18, the control section 21 controls the power source of the pair of 3D glasses 1a to change from being turned on to being turned off so as to control the lens driver 22 to stop operating. That is, the control section 21 controls the power source of the pair of 3D glasses 1a to change from being turned on to being turned off when the user takes off the pair of 3D glasses 1a.

According to the pair of 3D glasses 1a, it is possible to control the power source of the pair of 3D glasses 1a to turned on or off depending on whether or not the pair of 3D glasses 1a is being worn by a user, respectively.

### [3] Main Points

As described above, the pair of 3D glasses 1a is an electronic glasses which electrically carries out the function control. The pair of 3D glasses 1a includes the optical detecting section, which is provided in the frame 11, for detecting whether or not the pair of 3D glasses 1a is being worn by a user. The optical detecting section includes (i) the LED 17 which emits detection light S used to detect a user who is wearing the pair of 3D glasses 1a and (ii) a PD 18 which receives the detection light S which has been emitted by the LED 17 and is then reflected from the user.

According to the pair of 3D glasses 1a, the detection light S, which has been emitted by the LED 17 of the frame 11, is reflected from a user and is then received by the PD 18. Specifically, in a case where the user is wearing the pair of 3D glasses 1a, the detection light S, which has been emitted by the LED 17, is reflected from the user and is then received by the PD 18. Whereas, in a case where the pair of 3D glasses 1a is not being worn by the user, the detection light S, which has been emitted by the LED 17, is not reflected from the user and accordingly will not be received by the PD 18.

According to the pair of 3D glasses 1a, it is possible to detect, in accordance with a detected result of detection light S, whether or not the pair of 3D glasses 1a is being worn by the user, without the optical detecting section being in contact with the user.

According to the present embodiment, it is therefore possible to provide the pair of 3D glasses 1a which can properly detect whether or not the pair of 3D glasses 1a is being worn by a user, regardless of whether or not the user is wearing a pair of corrective glasses.

### [4] Modified Example

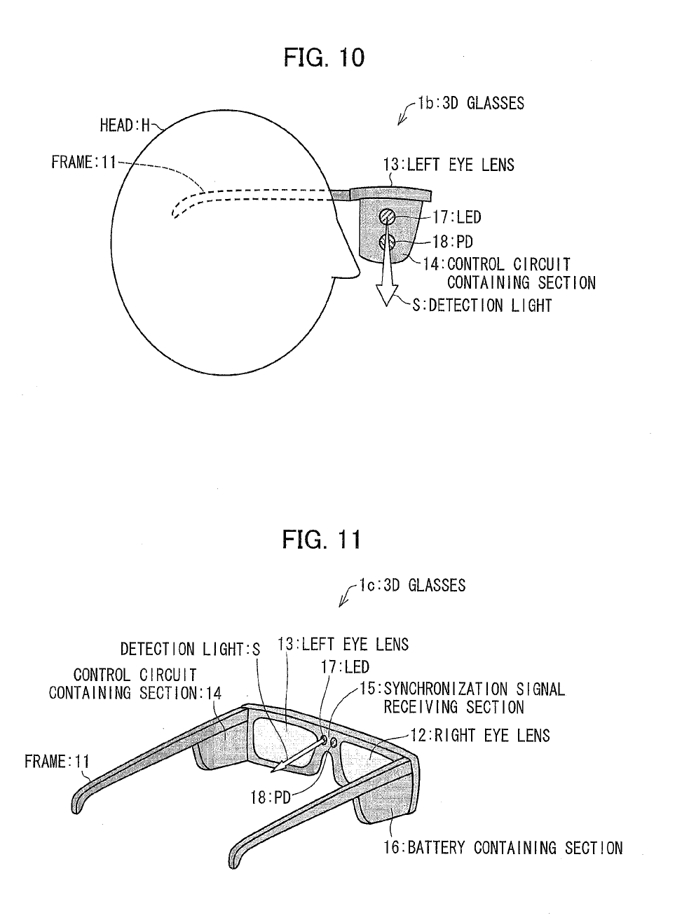

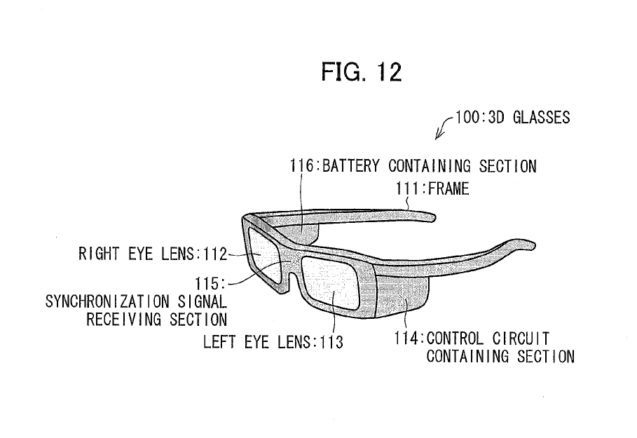

According to the present embodiment, the LED 17 and the PD 18, which constitute the optical detecting section, are provided in the temple part of the frame 11 of the pair of 3D glasses 1a. However, the present embodiment is not limited to this. The LED 17 and the PD 18 can be, for example, provided in a rim part of the frame 11 (see FIG. 10).

FIG. 10 is a schematic view illustrating a first modified example of the pair of 3D glasses 1a in accordance with the present embodiment. A pair of 3D glasses 1b is configured as a pair of flip-up glasses in which a rim part of a frame 11 supporting a right eye lens 12 and a left eye lens 13 is rotatably connected with a temple part of the frame 11 (see FIG. 10). According to the pair of flip-up 3D glasses 1b, it is preferable that an LED 17 and a PD 18 be provided in the rim part of the frame 11 so that a relative location of the LED 17 and the PD 18 with respect to a user changes in conjunction with the right eye lens 12 and the left eye lens 13.

In a state where the right eye lens 12 and the left eye lens 13 are flipped up, detection light S, which has been emitted by the LED 17, is not reflected from a head H of the user, and therefore is not received by the PD 18. In the state where the right eye lens 12 and the left eye lens 13 are flipped up, the control section 21 therefore controls (i) the lens driver 22 to stop operating and (ii) the power source of the pair of 3D glasses 1b to turn off. This makes it possible to reduce power which is unnecessarily consumed by the pair of 3D glasses 1b, and it is therefore possible to extend operating time of the pair of 3D glasses 1b.

Alternatively, the LED 17 and the PD 18 can be provided in a bridge part of the frame 11 (see FIG. 11).

FIG. 11 is a schematic view illustrating a second modified example of the pair of 3D glasses 1a in accordance with the present embodiment. A pair of 3D glasses 1c is configured so that an LED 17 and a PD 18 are provided in the bridge part of the frame 11 (see FIG. 11).

The location where the LED 17 and the PD 18 are provided is not limited in particular, provided that they are located so that the PD 18 can detect detection light S which has been emitted by the LED 17 and is then reflected from the user.

### [5] Recapitulation of Embodiment

As described above, in order to solve the foregoing conventional problem, a feature of a pair of electronic glasses, which electrically carries out function control, of the present embodiment resides in including: optical detecting means, provided in a frame of the pair of electronic glasses, for detecting whether or not the pair of electronic glasses is being worn by a user, the optical detecting means including: (i) light-emitting means for emitting detection light based on which the optical detecting means detects whether the user is wearing the pair of electronic glasses, and (ii) light-receiving means for receiving the detection light which has been emitted by the light-emitting means and is then reflected from the user.

With the configuration, the light-emitting means and the light-receiving means are provided so that the light-receiving means receives detection light which has been emitted by the light-emitting means and is then reflected by the user.

This allows the light-receiving means to receive the detection light in a case where the user is wearing the pair of electronic glasses. This is because the light, which has been emitted by the light-emitting means, is reflected by the user. Whereas, the light-receiving means cannot receive the detection light in a case where the pair of electronic glasses is not being worn by the user. This is because the detection light, which has been emitted by the light-emitting means, is not reflected by the user.

According to the configuration, it is possible to detect, in accordance with a detected result of detection light S, whether or not the pair of 3D glasses 1a is being worn by the user, without the optical detecting section being in contact with the user.

According to the present embodiment, it is therefore possible to provide the pair of electronic glasses which can properly detect whether or not the pair of electronic glasses is being worn by a user, regardless of whether or not the user is wearing a pair of corrective glasses.

According to the pair of electronic glasses of the present embodiment, it is preferable that the light-emitting means intermittently emits the detection light.

According to the configuration, the light-emitting means intermittently emits detection light. This makes it possible to reduce power consumption, as compared to a configuration in which detection light is continuously emitted.

According to the pair of electronic glasses of the present embodiment, it is preferable that the light-emitting means continuously emits the detection light, regardless of whether a power source of the pair of electronic glasses is turned on or off.

It is preferable that the pair of electronic glasses of the present embodiment further includes: control means for controlling, in accordance with a result detected by the optical detecting means, whether to turn on or off the power source of the pair of electronic glasses, the control means controlling the power source of the pair of electronic glasses to be turned on when the detection light, which has been emitted by the light-emitting means, is received by the light-receiving means.

According to the configuration, the light-emitting means continuously emits detection light regardless of whether the power source of the pair of electronic glasses is turned on or off, and the control means automatically controls the power source of the pair of electronic glasses to be turned on when the detection light, which has been emitted by the light-emitting means, is received by the light-receiving means. That is, the control means controls the power source of the pair of electronic glasses to be turned on when a user puts on the pair of electronic glasses.

This makes it possible to provide the pair of electronic glasses which (i) properly detects whether or not the pair of electronic glasses is being worn by a user, regardless of whether the power source of the pair of electronic glasses is turned on or off and (ii) automatically controls the power source of the pair of electronic glasses to change from being turned off to being turned on

According to the pair of electronic glasses of the present embodiment, it is preferable that the control means controls the power source of the pair of electronic glasses to be turned off when the detection light, which has been emitted by the light-emitting means, is not received by the light-receiving means.

According to the configuration, the control means automatically controls the power source of the pair of electronic glasses to be turned off when the detection light, which has been emitted by the light-emitting means, is not received by the light-receiving means. That is, the control means controls the power source of the pair of electronic glasses to be turned off when the user takes off the pair of electronic glasses.

This makes it possible to provide the pair of electronic glasses which (i) properly detects that the pair of electronic glasses is not worn by a user, regardless of whether or not the user is wearing a pair of corrective glasses and (ii) automatically controls the power source to be turned off.

According to the pair of electronic glasses of the present embodiment, it is preferable that the optical detecting means is provided in a rim part of the frame, which rim part supports a lens.

According to the pair of electronic glasses of the present embodiment, it is preferable that the rim part of the flame is provided so as to be rotatable in a direction in which the user views while the user is wearing the pair of electronic glasses.

According to the configuration, the optical detecting means is provided in the rim part of the frame which rim part supports the lenses, and the rim part is rotatably provided. With the configuration, in a case where, for example, the rim part is rotated so that the lenses are flipped up, the optical detecting means is moved together with the lenses, and accordingly a relative location of the optical detecting means with respect to the user changes. In the state where the lenses are flipped up, detection light, which has been emitted by the light-emitting means, is not therefore received by the light-receiving means. Accordingly, the device power source of the pair of electronic glasses is turned off.

According to the configuration, it is possible to reduce power which is unnecessarily consumed by the pair of electronic glasses.

It is preferable that the pair of electronic glasses of the present embodiment further includes: charging control means for controlling a rechargeable battery in the frame to be charged, the charging control means controlling the rechargeable battery to stop charging when the detection light, which has been emitted by the light-emitting means, is received by the light-receiving means.

According to the configuration, the charging control means controls the rechargeable battery to stop charging when the detection light, which has been emitted by the light-emitting means, is received by the light-receiving means. That is, the charging control means controls the rechargeable battery not to be charged, in a case where the power source of the pair of electronic glasses is turned on and is therefore in an operating state.

This makes it possible to prevent a trouble, such as gas generation from the rechargeable battery and/or liquid leakage from inside of the rechargeable battery, which is caused when the rechargeable battery is overcharged due to a defect of a circuit or the rechargeable battery.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention is suitably applicable to a pair of electronic glasses such as a pair of 3D glasses or a pair of varifocal electronic glasses which electrically carries out function control.

### REFERENCE SIGNS LIST

1a: 3D glasses (electronic glasses)
1b: 3D glasses (electronic glasses)
1c: 3D glasses (electronic glasses)
15: Synchronization signal receiving section
17: LED (light-emitting means)
18: PD (light-receiving means)
21: Control section (control means, charging control means)
S: Detection light

1. A pair of electronic glasses which electrically carries out function control, said pair of electronic glasses comprising:
optical detecting means, provided in a frame of said pair of electronic glasses, for detecting whether or not said pair of electronic glasses is being worn by a user,
the optical detecting means including:
light-emitting means for emitting detection light based on which said optical detecting means detects whether the user is wearing said pair of electronic glasses, and
light-receiving means for receiving the detection light which has been emitted by the light-emitting means and is then reflected from the user.

2. The pair of electronic glasses as set forth in claim 1, wherein:
the light-emitting means intermittently emits the detection light.

3. The pair of electronic glasses as set forth in claim 1, wherein:
the light-emitting means continuously emits the detection light, regardless of whether a power source of said pair of electronic glasses is turned on or off.

4. A pair of electronic glasses as set forth in claim 3, further comprising:
control means for controlling, in accordance with a result detected by the optical detecting means, whether to turn on or off the power source of said pair of electronic glasses,
the control means controlling the power source of said pair of electronic glasses to be turned on when the detection light, which has been emitted by the light-emitting means, is received by the light-receiving means.

5. The pair of electronic glasses as set forth in claim 4, wherein:
the control means controls the power source of said pair of electronic glasses to be turned off when the detection light, which has been emitted by the light-emitting means, is not received by the light-receiving means.

6. The pair of electronic glasses as set forth in claim 1, wherein:
the optical detecting means is provided in a rim part of the frame, which rim part supports a lens.

7. The pair of electronic glasses as set forth in claim 6, wherein:
the rim part of the flame is provided so as to be rotatable in a direction in which the user views while the user is wearing said pair of electronic glasses.

8. A pair of electronic glasses as set forth in claim 1, further comprising:
charging control means for controlling a rechargeable battery in the frame to be charged,
the charging control means controlling the rechargeable battery to stop charging when the detection light, which has been emitted by the light-emitting means, is received by the light-receiving means.
